(19) United States
(12) Patent Application Publication
(10) Pub. No.: US 2025/0021833 A1
(43) Pub. Date: Jan. 16, 2025

(54) AUTOMATED CONTACT CENTER BASED ON OBFUSCATED KNOWLEDGE BASE

(71) Applicant: Cisco Technology, Inc., San Jose, CA (US)

(72) Inventors: Anupam Mukherjee, Bangalore (IN); Nala Prasad Kamath, Bangalore (IN)

(21) Appl. No.: 18/349,424

(22) Filed: Jul. 10, 2023

(51) Int. Cl. G06N 5/022; H04L 9/00

(52) U.S. Cl. CPC G06N 5/022; H04L 9/008

(57) ABSTRACT

A method, computer system, and computer program product are provided for responding to user queries. A plurality of metadata objects are extracted from a plurality of knowledge artifacts in a database. A portion of the plurality of metadata objects is encrypted using homomorphic encryption to generate a plurality of encrypted embeddings, wherein each encrypted embedding relates to content of a knowledge artifact. A plurality of encrypted similarity scores are received that are generated by processing a query, received from a user, against the plurality of encrypted embeddings. The plurality of encrypted similarity scores are decrypted. A particular knowledge artifact is identified based on the decrypted plurality of similarity scores. A response is provided to the user based on the particular knowledge artifact.

### TECHNICAL FIELD

The present disclosure relates generally to an automated contact center for responding to user queries.

### BACKGROUND

Artificial agents, also referred to as virtual agents or chatbots, are software-based entities that are increasing employed to provide services such as artificial agents or chatbots that can assist users. An artificial agent can employ machine learning techniques, such as natural language processing and natural language understanding, to process and respond to customer inquiries and requests. Artificial agents can also expand the number of users that a contact center can handle simultaneously, unlike human-staffed call centers which are limited to the size of the contact center's staff. Thus, artificial agents can help streamline customer support operations, enhance efficiency, and deliver consistent and satisfactory experiences to customers.

### BRIEF DESCRIPTION OF THE DRAWINGS

FIG. 1 is a block diagram of a network environment, according to an example embodiment.

FIG. 2 is a hierarchical representation of knowledge artifact types and corresponding metadata, according to an example embodiment.

FIG. 3 is a flowchart of a method for generating metadata for knowledge artifacts, according to an example embodiment.

FIG. 4 is a flowchart of a method for cloud-based indexing of knowledge artifacts and corresponding metadata, according to an example embodiment.

FIG. 5 is a diagram of a process for generating encrypted similarity scores, according to an example embodiment.

FIG. 6 is a flowchart of a method for identifying knowledge artifacts matching a user query, according to an example embodiment.

FIG. 7 is a diagram of a process for obtaining knowledge artifacts matching a user query, according to an example embodiment.

FIG. 8 is a diagram of a process for performing cloud-based identification of knowledge artifacts, according to an example embodiment.

FIG. 9 is a flowchart of a method for identifying knowledge artifacts matching a user query, according to an example embodiment.

FIG. 10 is a diagram of a process for performing identification of knowledge artifacts, according to an example embodiment.

FIG. 11 is a block diagram of a device that may be configured to perform operations to connect radio base stations to data centers, as presented herein.

### DETAILED DESCRIPTION

### Overview

According to one embodiment, techniques are provided for responding to user queries. A plurality of metadata objects are extracted from a plurality of knowledge artifacts in a database. A portion of the plurality of metadata objects is encrypted using homomorphic encryption to generate a plurality of encrypted embeddings, wherein each encrypted embedding relates to content of a knowledge artifact. A plurality of encrypted similarity scores are received that are generated by processing a query, received from a user, against the plurality of encrypted embeddings. The plurality of encrypted similarity scores are decrypted to obtain a decrypted plurality of similarity scores. A particular knowledge artifact is identified based on the decrypted plurality of similarity scores. A response is provided to the user based on the particular knowledge artifact.

### Example Embodiments

Present embodiments relate generally to an automated contact center for responding to user queries, and more specifically, to an automated contact center in which control of data is retained by the manufacturer or service provider rather than sharing the data directly with any third-party computing entities.

An automated contact center can utilize an artificial agent to handle incoming user queries, such as telephone calls or chat messages received from a user who has a question about a product. The artificial agent may employ machine learning techniques such as natural language understanding to analyze a user's query and identify relevant information that can be provided to the user as an answer. For example, a user may provide a query relating to how to use a particular function of a product, and an artificial agent may provide a natural language response to the user that is generated by analyzing documentation of the product.

A customer (i.e., a manufacturer of a product or provider of a service) may not desire to support their own artificial agent, and may instead use a third-party service that can specialize in artificial agents. In order to support such a third-party artificial agent, conventional approaches would require the third party service to be provided with the data that is necessary to respond to user queries. This data typically may include articles (e.g., product documentation), frequently-asked questions (FAQs) and corresponding answers, and the like. However, for various reasons, many customers may prefer to keep this data private. For example, the data may include trade secrets, sensitive information, or other proprietary information.

To address this problem, the embodiments presented herein provide techniques for obfuscating the data that is necessary to support a third-party artificial agent so that the third party does not have access to the underlying customer data. In particular, homomorphic encryption is employed in order to enable processing of the data without directly accessing the data. Homomorphic encryption is a form of encryption that enables computations to be performed on encrypted data without having to decrypt the data first. The resulting computations are also left in an encrypted form which, when decrypted, result in an output that is identical to that produced if the operations had been performed on the unencrypted data. In present embodiments, a vector space model is generated in which the customer data is converted into vector embeddings that can be compared to an embedding of the user's query to identify particular data objects that most closely match the user's query (and are therefore likely to contain answers to the user's question).

In particular, the embeddings are encrypted using homomorphic encryption on the customer's premises, and only once encrypted are the embeddings provided to the third party. The customer can then homomorphically encrypt user queries in a similar manner and provide those queries to the third party, which processes the encrypted query's embedding against the vector space of embeddings to identify a subset of similar embeddings that correspond to specific data objects in the customer data. The customer can then provide those specific data objects to the third-party artificial agent, which generates a response to the user query using the specific data objects after further artificial intelligence-driven filtration. Thus, a third party only ever has access to encrypted customer data, which the third party cannot decrypt, and specific data objects that are determined to be relevant to the user's query, which the third party also may not obtain.

Thus, present embodiments provide an improved approach to data obfuscation that prevents large-scale access of data by a third party. Instead, the third party can only access individual data objects when permitted, and the third party may not be able to determine the relevance of those data objects. The techniques described herein provide the practical application of enabling an artificial agent to be fully supported with customer data in a manner that does not actually cede access to that data by the third party. Moreover, the embodiments presented herein include mechanisms that improve the likelihood that returned data objects are highly relevant to a user's query by ensuring that the context of the user's query matches the context of data objects. Accordingly, present embodiments utilize homomorphic encryption to improve the technical fields of artificial intelligence agents and data security.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description and appended claims, or may be learned by the practice of embodiments as set forth hereinafter.

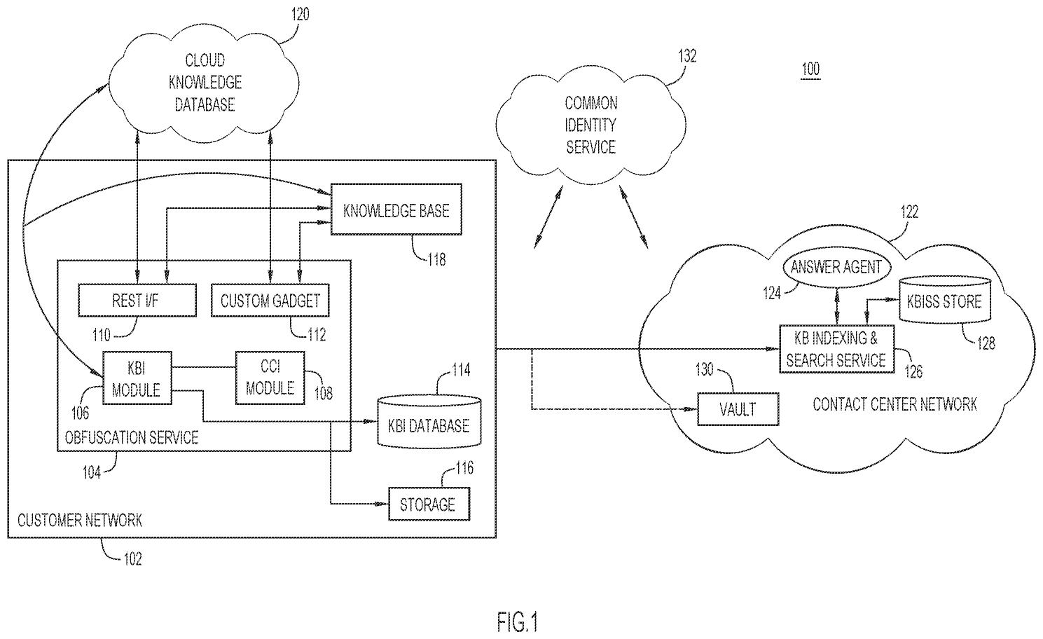

Embodiments will now be described in detail with reference to the Figures. Reference is now made to FIG. 1. FIG. 1 is a block diagram of a network environment 100, according to an example embodiment. As depicted, network environment 100 includes a customer network 102, a cloud knowledge base 120, a contact center network 122, and a common identity service 132. Customer network 102 may include an obfuscation service 104, which in turn includes a knowledge base ingestion (KBI) module 106, a contact center interface (CCI) module 108, a representational state transfer (REST) interface (I/F) 110, and a custom gadget 112. Contact center network 122 may include an answer agent 124, a knowledge base indexing and search service (KBISS) 126, a KBISS stores 128, and a vault 130. It is to be understood that the functional division among components have been chosen for purposes of explaining various embodiments and is not to be construed as a limiting example. Each element of network environment 100 may be a physical entity or a virtual entity, and may include one or more modules or units to perform various functions of the embodiments described below. Each element of network environment 100 may be implemented by any combination of any quantity of software and/or hardware modules or units.

Customer network 102 may include an on-premises network, which refers to a computer network infrastructure that is built and maintained by a customer organization within their own physical premises or facilities. Customer network 102 may include a collection of interconnected devices, such as computers, servers, routers, switches, and other networking equipment, that enable communication and data sharing within the organization. Customer network 102 may be used by an organization to establish a private and secure environment for internal operations. Customer network 102 can be tailored to meet specific requirements and provide greater control over network configuration, security policies, and data storage. Thus, customer network 102 provides an organization control over their network infrastructure and enhanced security over their data.

In the embodiments presented herein, customer network 102 may include components that perform operations relating to the ingestion and management of data that is used to support an artificial agent (e.g., answer agent 124). This data may include documentation for products or services, such as frequently-asked questions and corresponding answers, and articles spanning one or more paragraphs. The individual data items may be referred to herein as knowledge artifacts. Additionally or alternatively, customer network 102 may include components that relate to the generation of homomorphically-encrypted embeddings and user queries, and/or the retrieval of particular knowledge artifacts or portions thereof.

Knowledge base ingestion (KBI) database, storage 116, knowledge base 118, and/or cloud knowledge base 120 may each include one or more databases that can employ various storage techniques, such as any non-volatile storage media known in the art. For example, KBI database, storage 116, knowledge base 118, and/or cloud knowledge base 120 can be implemented with a tape library, optical library, one or more independent hard disk drives, or multiple hard disk drives in a redundant array of independent disks (RAID). Similarly, data stored by KBI database, storage 116, knowledge base 118, and/or cloud knowledge base 120 may conform to any suitable storage architecture known in the art, such as a file, a relational database, an object-oriented database, and/or one or more tables. In particular, storage 116, knowledge base 118, and/or cloud knowledge base 120 may store knowledge artifacts, such as frequently-asked questions and corresponding answers, as well as articles that include one or more paragraphs or other sections. Additionally, storage 116, knowledge base 118, and/or cloud knowledge base 120 may store metadata associated with each knowledge artifact, which can include universal unique identifiers (UUIDs) that are assigned to each knowledge artifact. The metadata may include results of processing the knowledge artifacts in accordance with present embodiments. In the depicted embodiment, KBI database 114, storage 116 and knowledge base 118 may be on-premises storage with regard to customer network 102, whereas cloud knowledge base 120 may be a cloud storage service offered by a third party. In one embodiment, knowledge base 118 and/or cloud knowledge base 120 may store knowledge artifacts, whereas KBI database 114 and/or storage 116 may store homomorphically-encrypted embeddings (e.g., a vector space model) and other metadata, such as UUIDs for each knowledge artifact, the relationships between each embedding, UUID, and knowledge artifact, hashes of each knowledge artifact, storage locations of each knowledge artifact, and/or topics or summaries of each knowledge artifact.

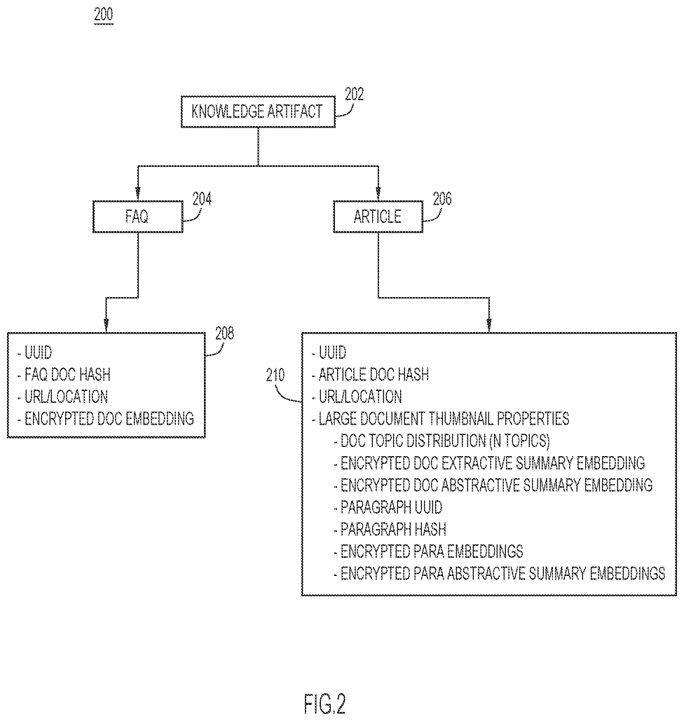

Obfuscation service 104 may ingest knowledge artifacts and process the knowledge artifacts to generate the data that is stored by storage 116. Obfuscation service 104 can obtain the knowledge artifacts from knowledge base 118 and/or cloud knowledge base 120. Obfuscation service 104 may obtain knowledge artifacts via one or more application programming interfaces, such as REST I/F 110 and/or custom gadget 112, the latter of which may be a proprietary interface developed by the organization associated with customer network 102. Each knowledge artifact can include metadata indicating whether a particular knowledge artifact is a frequently-asked question and corresponding answer or an article. For each knowledge artifact type (i.e., frequently-asked question and corresponding answer vs. article), obfuscation service 104 may employ different processing techniques, as will be discussed in further detail below with reference to FIG. 2.

In particular, KBI module 106 of obfuscation service 104 may employ one or more machine learning models, such as a natural language processing (NLP) model, to process knowledge artifacts in order to generate a summary or title for each knowledge artifact. The resulting summaries or titles can then be processed to generate embeddings (e.g., vector embeddings). Prior to generating embeddings, the summaries or titles may be pre-processed to perform operations such as stemming or lemmatization. The resulting embeddings may then be encrypted using homomorphic encryption, and the encrypted embeddings can be provided to KBI database 114 and/or storage 116. In some embodiments, any metadata regarding knowledge artifacts may be stored to KBI database 114, and the encrypted embeddings may be stored to storage 116. In some embodiments, KBI module 106 receives user queries and converts the user queries to encrypted embeddings.

Obfuscation service 104 may monitor knowledge base 118 and/or cloud knowledge base 120 to identify when there is an update to either, or both, databases. An update may include the addition of knowledge artifacts, modification of knowledge artifacts, and/or deletion of knowledge artifacts. Obfuscation service 104 may identify an update using REST I/F 110 and/or custom gadget 112, which can receive notifications of updates to a knowledge base or access a knowledge base in an ad hoc manner to check for updates. When an update is identified, KBI module 106 may update the corresponding encrypted embeddings as follows: a new encrypted embedding can be generated when a new knowledge artifact is added, an encrypted embedding corresponding to a deleted knowledge artifact may be deleted from storage, and an encrypted embedding corresponding to a modified knowledge artifact may be replaced with a new encrypted embedding that is generated based on the modified knowledge artifact.

CCI module 108 may act as an interface between obfuscation service 104 and contact center network 122 in order to transmit and receive data between customer network 102 and contact center network 122. In some embodiments, CCI module 108 provides metadata and encrypted embeddings to contact center network 122. CCI module 108 may also receive user queries and once converted to encrypted embeddings, provide those encrypted embeddings to contact center network 122.

Contact center network 122 may include answer agent 124, KBISS 126, KBISS store 128, and optionally, vault 130. In general, contact center network 122 may receive user queries, which can be handled by answer agent 124. The user queries may be converted into encrypted embeddings, which in various embodiments can be performed by contact center network 122 or customer network 102. These user query encrypted embeddings can then be compared to the knowledge artifact encrypted embeddings in order to identify one or more closest knowledge artifact encrypted embeddings, which can be utilized to identify corresponding knowledge artifacts that relate to the user query. These identified knowledge artifacts can be used by answer agent 124 to generate responses to user queries, which can also be provided to users via answer agent 124.

Answer agent 124 may include one or more natural language processing models that enable answer agent 124 to interact with users who communicate with contact center network 122. In some embodiments, answer agent 124 may engage in text-based communication with users, whereas in other embodiments, answer agent 124 may employ a synthesized voice to communicate with users in a natural language fashion. Any voice utterances received from users may be converted from speech to text prior to processing via answer agent 124, and likewise, text-to-speech conversion may be employed to provide responses to the users. User queries received by answer agent 124 may be provided to obfuscation service 104, which can convert the user queries into encrypted embeddings that can be provided to KBISS 126.

KBISS 126 may process the encrypted embeddings of user queries against a set of encrypted embeddings that correspond to the knowledge artifacts; this set of encrypted embeddings may form a vector space model. The vector space model may be stored in KBISS store 128, which can include any conventional or other database, and which is accessed by KBISS 126 during comparison operations. As homomorphic encryption is employed, KBISS 126 may not identify which embeddings are closest to the user query embedding, but may rather generate encrypted similarity scores. The resulting encrypted similarity scores can be decrypted (e.g., by KBI module 106) in order to identify a closest one or more embeddings, and the identified closest embedding(s) can be used to identify the corresponding knowledge artifact(s). CCI module 108 may provide an identified knowledge artifact to answer agent 124, which processes the knowledge artifact using natural language processing to generate a response to the user query. Thus, contact center network 122 cannot access the underlying knowledge artifacts in general, but rather, processes homomorphically-encrypted data, with obfuscation service 104 performing any homomorphic encryption and/or decryption operations.

In some embodiments, vault 130 is optionally included in contact center network 122. Vault 130 may be a hardened storage container that contains encrypted data to which contact center network 122 may only selectively be provided access. Vault 130 may store a homomorphically encrypted library of knowledge artifact embeddings and corresponding metadata the provides a context for each knowledge artifact. The homomorphically encrypted library may be specific to each customer. Additionally, vault 130 may store keys for decrypting the data. In embodiments in which vault 130 is included, the encrypted similarity scores that are generated by KBISS 126 can be decrypted to identify embeddings, by their UUIDs, that are closest to the user query embedding and that match a context (e.g., matching a category of title or keywords in a summary). Vault 130 can then selectively decrypt knowledge artifacts associated with the identified UUIDs and provide those artifacts to answer agent 124. Thus, contact center network 122 and its components may freely access knowledge base data, but rather, can only provide encrypted similarity scores to vault 130, which outputs only the knowledge artifacts that are determined to be relevant.

Common identity service 132 is an identity service that can perform authentication operations for customer network 102 and contact center network 122. In particular, common identity service 132 may perform authentication between customer network 102 and contact center network 122 prior to customer network 102 and contact center network 122 exchanging data, such as encrypted embeddings, knowledge artifacts, and/or user queries.

With reference now to FIG. 2, a hierarchical representation 200 is provided of knowledge artifact types and corresponding metadata, according to an example embodiment. As shown, each knowledge artifact 202 may correspond to either a (set of) frequently asked questions (FAQ) 204 and corresponding answers, or an article 206. In some embodiments, a trained machine learning classifier is employed to classify knowledge artifacts 202 into a FAQ 204 category or an article 206 category. In other embodiments, each knowledge artifact may be labeled with respect to its category.

When each knowledge artifact 202 is processed by obfuscation service 104, metadata is generated. For a FAQ 204, metadata 208 includes a UUID, a hash of the document, and a storage location (e.g., a uniform resource locator (URL) or disk storage location). Additionally, for a FAQ 204, an encrypted document embedding can be generated. For a large FAQ (e.g., a FAQ surpassing a threshold size), individual embedding may be generated for each question and answer. In particular, in any embodiment described herein, a FAQ exceeding a threshold size may be processed as an article would be processed rather than a FAQ. For an article 206, metadata 210 may include a UUID, a hash of the article, a storage location, and one or more properties of the document: a topic or distribution of topics (e.g., a list of topics covered in the article), an encrypted embedding of a summary that is extracted from the article using natural language processing, an encrypted embedding of an abstract of the article, a UUID for each paragraph of the article, a hash for each paragraph in the article, an encrypted embedding of each paragraph, and/or an encrypted embedding for a summary, generated or provided, for each paragraph. The summary may include either or both of an extractive summary and/or an abstractive summary: an extractive summary may be generated by concatenating important sentences or paragraphs without requiring an understanding of the meaning of those sentences, whereas an abstractive summary may be a meaningful summary that is generated by a human or a natural language understanding model.

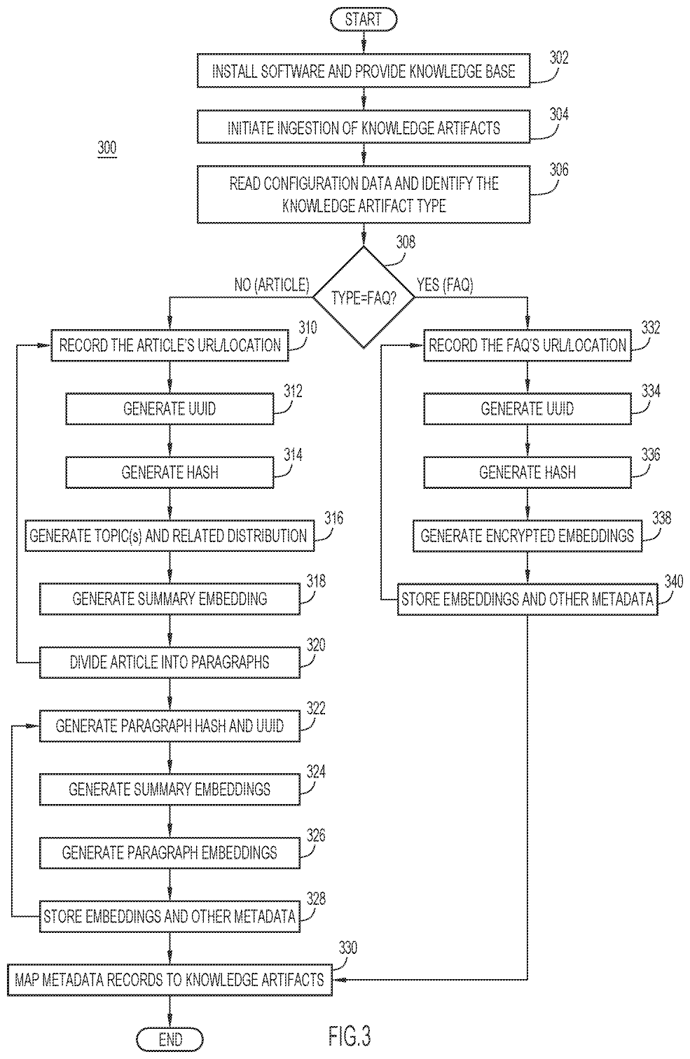

FIG. 3 is a flowchart of a method 300 for generating metadata for knowledge artifacts, according to an example embodiment.

Initially, software to support present embodiments is installed and a knowledge base is provided at operation 302. The software may be installed on a customer's premises, and can include an obfuscation service (e.g., obfuscation service 104) for ingesting knowledge artifacts and generating encrypted embeddings and metadata. The knowledge base (e.g., knowledge base 118 and/or cloud knowledge base 120) can be populated with any knowledge artifacts that a customer desires for supporting their products and/or services.

At operation 304, the ingestion of knowledge artifacts is initiated. The obfuscation service may initially obtain (or be provided with) knowledge artifacts from the knowledge base. At operation 306, the obfuscation service can analyze each knowledge artifact to identify each knowledge artifact's type (e.g., article or FAQ). Operation 308 determines whether each knowledge artifact is either an article or a FAQ; for an article, method 300 proceeds to operation 310, and for a FAQ, method 300 proceeds to operation 332.

At operation 310, the article's URL or other storage location is recorded. A UUID is generated for the article at operation 312, and a hash of the article is generated at operation 314. At operation 316, a topic for the article is generated as well as a related topic distribution. Natural language processing techniques may be employed to identify one or more topics for an article that can be used to classify the article as relating to a particular topic or domain. For example, an article about a storage device can be classified as either a solid state disk (SSD) or a magnetic storage hard drive. Thus, when a user query is specific to SSDs, the appropriate article can be selected (e.g., the article relating to SSDs). The topic distribution may include scores for the various topics for a given article, wherein each score indicates a likelihood that the article relates to or includes a given topic.

At operation 318, a summary embedding for the article is generated. A summary or abstract of the article may be used to generate the embedding, or, if a summary or abstract is not provided, a natural language processing model can generate a summary (including an abstractive summary and/or extractive summary). The summary is then converted into an embedding (e.g., a vector for a vector space model), and the embedding may be encrypted using homomorphic encryption. Operations 310 through 320 may be repeated for each article until the articles are processed accordingly.

The article is divided into its constituent paragraphs at operation 320. By processing the article on a paragraph level, specific portions of an article can be later identified for use in responding to a user query in order to utilize the most relevant portions of an article to a user. At operation 322, each paragraph is analyzed to generate a hash and a UUID for that paragraph, and summary embeddings are generated and encrypted using homomorphic encryption at operation 324. For short paragraphs (e.g., paragraphs within a threshold word count), the paragraph itself may be used to generate an embedding, whereas for longer paragraphs, a natural language processing model may be employed to generate a summary for the paragraph. At operation 326, embeddings may likewise be generated for each paragraph. The embeddings and other metadata are stored in a database at operation 328. In particular, the metadata may be stored in a separate database from the embeddings; in one embodiment, metadata may be stored in KBI database 114, and embeddings may be stored in storage 116. Operations 322 through 328 may be repeated for each paragraph until the paragraphs of an article are processed accordingly.

At operation 330, the database in which the embeddings and metadata records are stored is updated to map each embedding and metadata record to its corresponding knowledge artifact. Thus, knowledge artifacts can be identified using this mapping so that the UUID of an embedding can be utilized to identify its corresponding knowledge artifact (e.g., an article, a specific paragraph of an article, or a FAQ).

In the case that a knowledge artifact is a FAQ, method 300 proceeds at operation 332 to record the URL or other storage location of the FAQ. At operation 334, a UUID for the FAQ is generated, and at operation 336, a hash of each FAQ is generated. Encrypted embeddings are generated at operation 338; the embeddings may be generated using a natural language understanding model to identify a topic for each FAQ, and in some embodiments, these topics and/or embeddings are stored to a hardened storage such as vault 130.

At operation 340, the embeddings and other metadata may be stored to one or more storage locations; in some embodiments, the metadata may be stored in KBI database 114, and embeddings may be stored in storage 116. Operations 332 through 340 may be repeated until each FAQ is processed, and method 300 may proceed to operation 330 to map the metadata records to the knowledge artifacts as previously discussed.

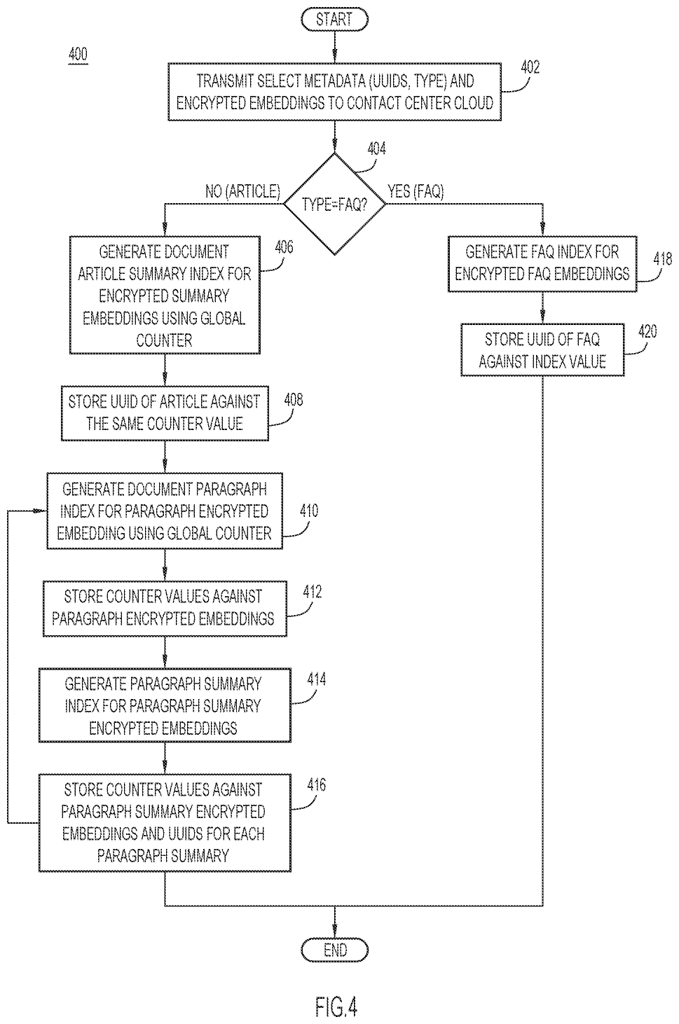

With reference to FIG. 4, a flowchart is provided depicting a method 400 of cloud-based indexing of knowledge artifacts and corresponding metadata, according to an example embodiment.

At operation 402, select metadata (e.g., UUIDs and knowledge artifact types) are transmitted along with the corresponding encrypted embeddings to a contact center cloud (e.g., contact center network 122). Once received, the contact center cloud determines whether each knowledge artifact is a FAQ or an article at operation 404. For an article, method 400 proceeds to operation 406 and generates a document article summary index for the encrypted document summary embeddings using a global counter. The global counter enables each individual article to be indexed in the contact center cloud. The UUID of each article is stored against the counter values in a cloud storage database at operation 408.

At operation 410, index values for the encrypted embedding of each paragraph of an article are generated using another global counter. These index values are likewise stored in the contact center cloud at operation 412; the stored values may include the UUID of the article and/or the UUID of the paragraph that is stored against a document paragraph index. At operation 414, index values for the encrypted embeddings of each paragraph's summary are generated and likewise stored with their corresponding UUIDs (e.g., the paragraph UUID as well as the article UUID) at operation 416. Operations 410 through 416 may be repeated for each article until each article is processed accordingly.

In the case that a knowledge artifact is a FAQ, method 400 proceeds to operation 418. At operation 418, a FAQ index is generated for the encrypted FAQ embeddings using a global counter. Thus, each FAQ is assigned its own index value. At operation 420, the UUID of each FAQ is stored against the index value in a contact center cloud storage database.

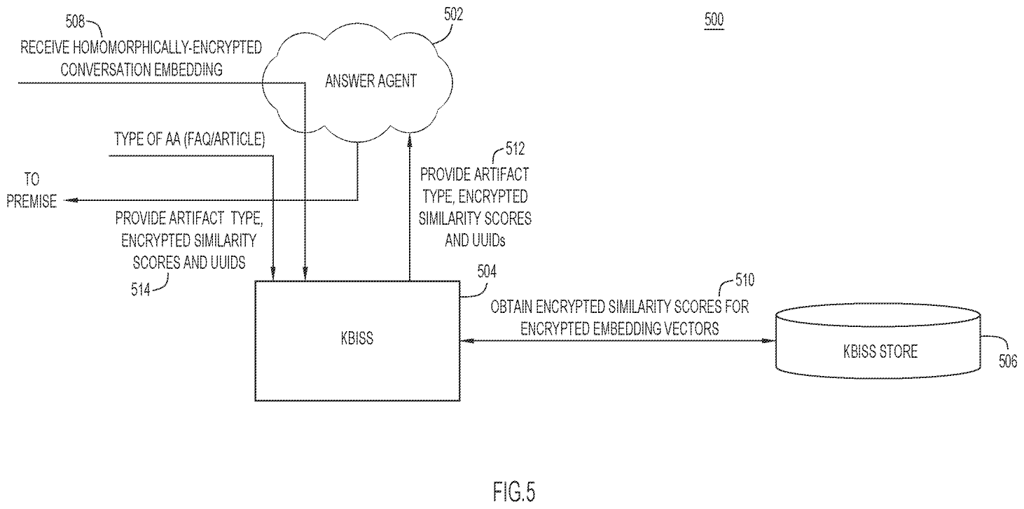

Referring now to FIG. 5, a diagram is provided depicting a process 500 for generating encrypted similarity scores, according to an example embodiment. Process 500 relates to a contact center service including an artificial agent 502, KBISS 504, and KBISS store 506, which may correspond to answer agent 124, KBISS 126, and KBISS stores 128, depicted and described in further detail with reference to FIG. 1.

At operation 508, a homomorphically-encrypted conversation embedding is received by KBISS 504. As input, KBISS 504 may receive artifact metadata and/or homomorphically-encrypted metadata embeddings from a customer network. The embedding may be generated by artificial agent 502 providing a user query to a customer network, which processes the query to generate the embedding and returns the embedding to the contact center service.

KBISS 504 may access KBISS store 506 to obtain encrypted similarity scores for encrypted embedding vectors at operation 510. In particular, KBISS 504 may provide output to KBMISS store 506 to cause KBISS store 506 to create an index for encrypted embeddings and to store metadata. KBISS 504 can perform operations that compare the conversation encrypted embedding against each embedding in KBISS store 506 using a similarity metric (e.g., cosine similarity) to generate encrypted similarity scores. At operation 512, the encrypted similarity scores may be provided to artificial agent 502, along with the artifact type for each related knowledge artifact and the corresponding UUID. Artificial agent 502 provides the artifact type, encrypted similarity scores, and UUIDs to the customer network at operation 514.

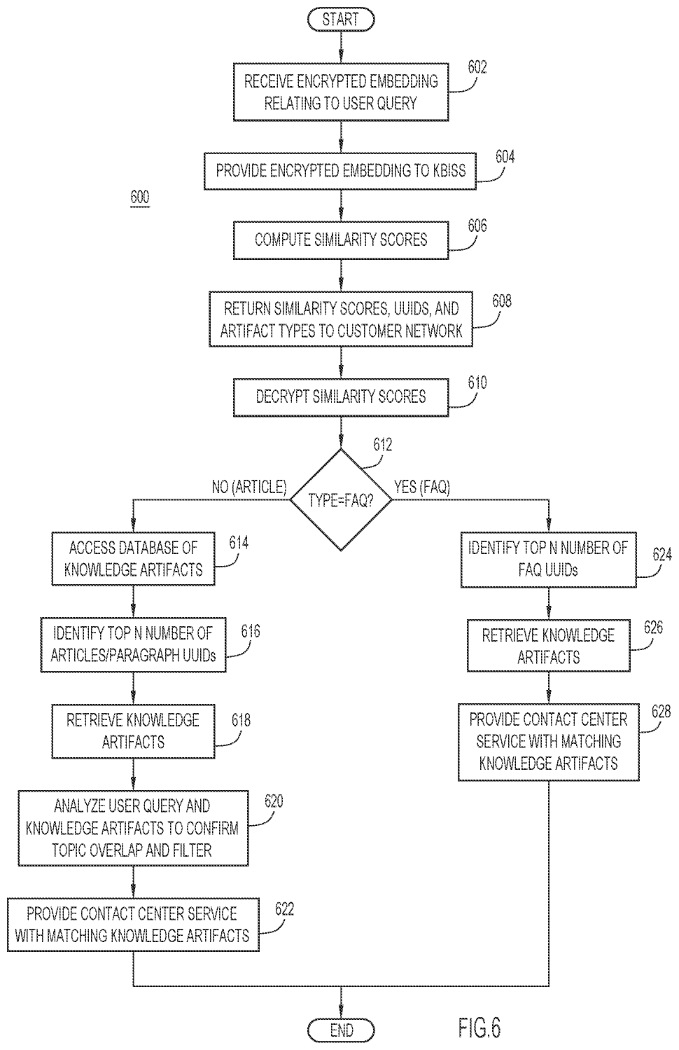

FIG. 6 is a flowchart of a method 600 for identifying knowledge artifacts matching a user query, according to an example embodiment.

At operation 602, an artificial agent receives an encrypted embedding corresponding to a user query (e.g., a user utterance provided to an answer agent). The encrypted embedding may be generated based on conversation data initially collected by the artificial agent, which is passed to a customer network for generation of the encrypted embedding. The encrypted embedding is provided to a contact center's KBISS module at operation 604, and similarity scores are computed at operation 606 by comparing the encrypted embedding to embeddings in the KBISS store. The similarity score may be computed by comparing the encrypted embedding with artifacts of the same type.

At operation 608, the KBISS module returns the encrypted similarity scores along with corresponding UUIDs and artifact types to the customer network's premise-based obfuscation service. The obfuscation service decrypts, on the customer network side, the similarity scores at operation 610, and at operation 612, method 600 branches depending on whether each encrypted embedding associated with the similarity scores is an article or a FAQ.

For articles, method 600 proceeds to operation 614 to access the database of knowledge artifacts and/or associated metadata. At operation 616, the obfuscation service identifies a top N number of article/paragraph UUIDs based on the decrypted similarity scores, including specific matching paragraphs based on the paragraph embeddings. In various embodiments, the number of articles and/or paragraphs returned can be adjustable and/or may include an article or paragraph with a highest overall similarity score or a number of articles or paragraphs with a highest N similarity scores (e.g., the three highest, the ten highest, etc.).

The obfuscation service retrieves the actual knowledge artifacts corresponding to the identified top N similarity scores from an on-premises database at operation 618. At operation 620, the obfuscation service analyzes the returned knowledge artifacts and the user query to determine that there is a topic overlap between the two. One or more natural language understanding models can be employed to determine that there is topic overlap, and any knowledge artifacts that do not have a common topic with the user query may be filtered out.

At operation 622, the obfuscation service provides the contact center service with the matching knowledge artifacts. Thus, the artificial agent can analyze the matching knowledge artifacts in order to generate a response to the user query.

In the case that a knowledge artifact is a FAQ, method 600 proceeds to operation 624 to identify a top N number of FAQ UUIDs using the decrypted similarity scores. In various embodiments, any desired number can be provided for N so that a top overall most similar FAQ UUID can be returned, or a number of FAQ UUIDs.

At operation 626, the corresponding actual knowledge artifacts for each returned FAQ are retrieved from the customer network using their UUIDs, and at operation 628, the obfuscation service provides the contact center service with the matching knowledge artifacts.

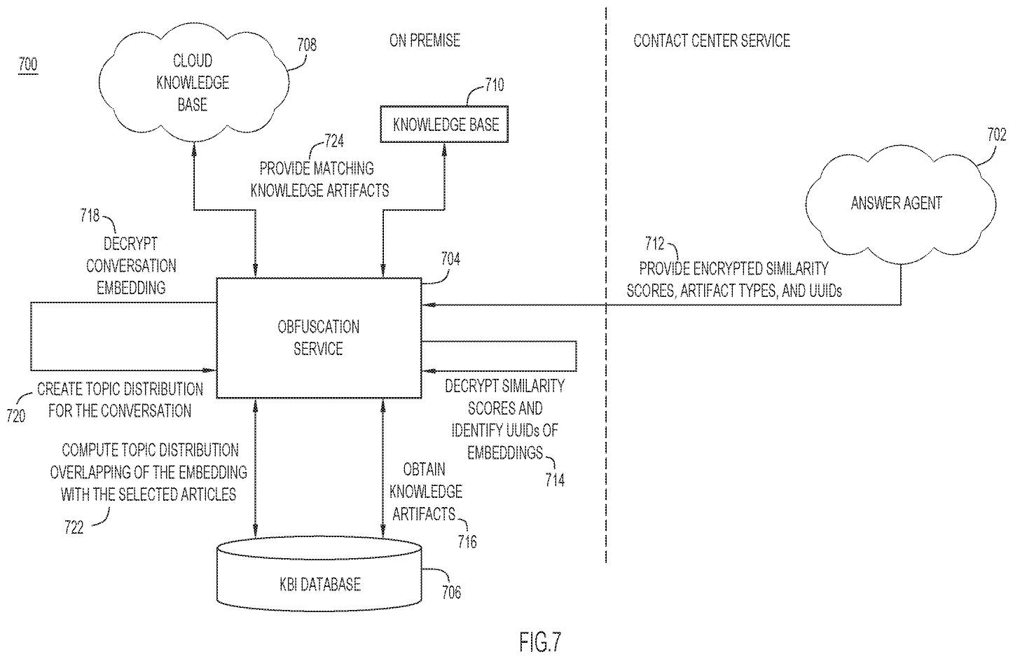

FIG. 7 is a diagram of a process 700 for obtaining knowledge artifacts matching a user query, according to an example embodiment. As depicted, process 700 involves an artificial agent 702 on a contact center service's side, and an obfuscation service 704, KBI database 706, and knowledge base 710 on a customer's on-premises network (e.g., a customer network). Also depicted is a cloud knowledge base 708 which may be external to both the customer network and contact center service.

At operation 712, artificial agent 702 provides to obfuscation service 704 the encrypted similarity scores obtained by comparing a user query embedding to knowledge artifact embeddings. Artificial agent 702 may also provide obfuscation service 704 with the type of artifact embedding for each embedding and the UUID for each embedding.

Once the encrypted similarity scores, artifact types, and UUIDs are received, obfuscation service 704 decrypts the similarity scores to identify one or more similar embeddings by their UUIDs at operation 714. At operation 716, obfuscation service 704 obtains the knowledge artifacts identified by their UUIDs from KBI database 706.

For knowledge artifacts that are articles, operations 718, 720, and 722 are performed to ensure there is a topic overlap between the user query and the topic of each article. At operation 718, the conversation embedding (e.g., the user query) is decrypted, and a topic for the distribution of the conversation is generated at operation 720 using natural language processing. At operation 722, a topic distribution overlapping is computed with the knowledge artifacts corresponding to the selected closest article embeddings in order to determine whether any knowledge artifacts do not share a topic overlap with the conversation embedding. Any knowledge artifacts that do not share a topic embedding may be omitted from further processing.

At operation 724, obfuscation service 704 accesses one or more databases (e.g., cloud knowledge base 708, knowledge base 710, etc.) using the location of each knowledge artifact to retrieve those knowledge artifacts. The retrieved knowledge artifacts can then be provided to artificial agent 702 for responding to a user query.

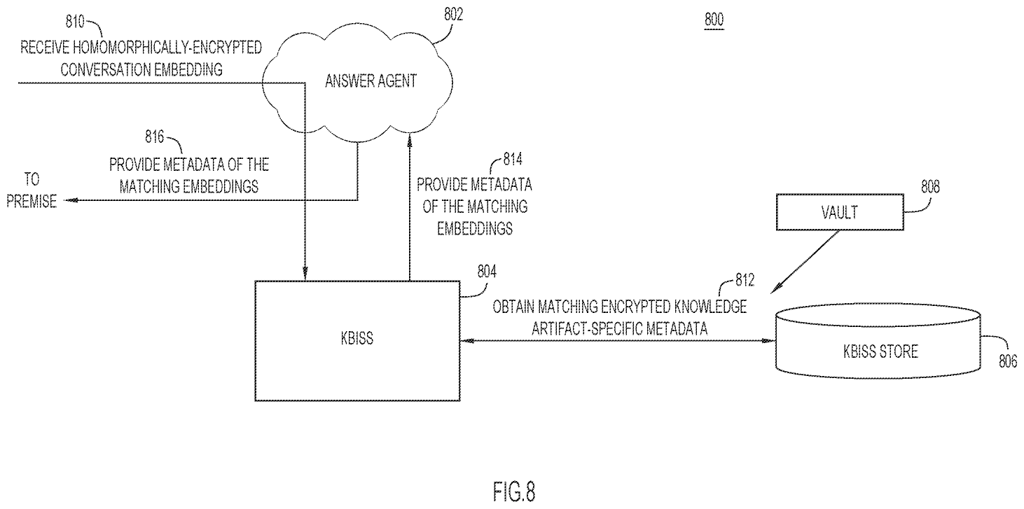

FIG. 8 is a diagram of a process 800 or performing cloud-based identification of knowledge artifacts, according to an example embodiment. Process 800 includes an artificial agent 802, KBISS 804, KBISS store 806, and vault 808. Initially, encrypted embeddings of knowledge artifacts and corresponding metadata is provided from a customer to the contact center service, which stores the data in KBISS store 806. The stored data may indicate a type of knowledge artifact for each embedding. KBISS 804 may provide as output to KBISS store 806 data for creating an index in KBISS store 806 that stores encrypted embeddings and metadata. Optionally, an obfuscated library is provided and stored in vault 808; the obfuscated library may include homomorphic encryption contexts and instructions for securely decrypting similarity scores.

At operation 810, artificial agent 802 receives an encrypted embedding corresponding to a user query. The encrypted embedding may be generated based on conversation data initially collected by the artificial agent, which is passed to a customer network for generation of the encrypted embedding. The encrypted embedding is provided to a contact center's KBISS module 804, and encrypted similarity scores are computed by comparing the encrypted embedding to embeddings in the KBISS store 806. KBISS 804 provides the encrypted similarity scores to vault 808, which decrypts the similarity scores and identifies matching knowledge artifact embeddings.

At operation 812, KBISS 804 receives metadata associated with the matching embeddings identified by vault 808. KBISS 804 can then provide the metadata of the matching embeddings to artificial agent 802 at operation 814, and in turn, artificial agent 802 can provide the metadata to the customer network at operation 816.

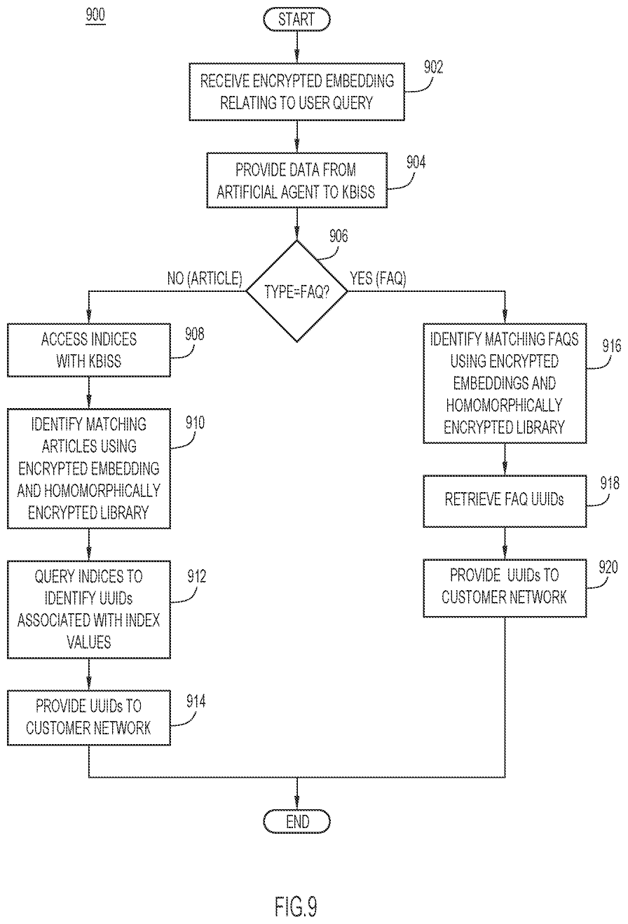

FIG. 9 is a flowchart of a method 900 for identifying knowledge artifacts matching a user query, according to an example embodiment.

An artificial agent receives an encrypted embedding relating to a user query at operation 902. The embedding may be generated and encrypted by a customer based on conversation data obtained by the artificial agent with a user. In the embodiment of FIG. 9, an artificial agent may be trained to specialize in either article-based responses or FAQ-based responses, and there may be one or more artificial agents of each type in the contact center service.

At operation 904, the artificial agent provides the encrypted embedding data to KBISS along with an indication of whether the artificial agent is an article-based agent or a FAQ-based agent. Method 900 branches at operation 906 depending on the type of agent.

In the case that the agent is an article-based agent, method 900 proceeds to operation 908. At operation 908, KBISS accesses various indices of different types, including a document article summary index for machine-generated summaries, a document article summary index for provided summaries (e.g., abstracts), a document article paragraph index, and/or a document article paragraph summary index.

At operation 910, KBISS identifies matching articles using the encrypted embedding, which can be provided to a vault for analysis. In particular, the vault can be a secured storage entity that is configured to receive encrypted embeddings, identify a top N number of matching articles using similarity scores computing using a homomorphically encrypted library of the vault, decrypt the similarity scores, and output index values and similarity scores for each selected article. At operation 912, KBISS can use the index values to query the various indexes in order to identify UUIDs that are associated with the index values.

At operation 914, KBISS can provide the UUIDs of matching articles to a customer network, which can use the UUIDs to retrieve the underlying knowledge artifacts. These knowledge artifacts can be used by an artificial agent to respond to a user. Paragraph-specific UUIDs can be used to indicate particular paragraphs in an article to ensure that an artificial agent applies more weight to those paragraphs when generating a response.

In the case that the agent is an article-based agent, method 900 proceeds to operation 916. At operation 916, KBISS can access a secured vault similarly to operation 910 in order to identify a top N matching FAQ index values. At operation 918, KBISS can use the index values to retrieve corresponding UUIDs by accessing the KBISS store, and at operation 920, KBISS can provide those matching UUIDs to the customer network for retrieval of the underlying FAQ knowledge artifacts.

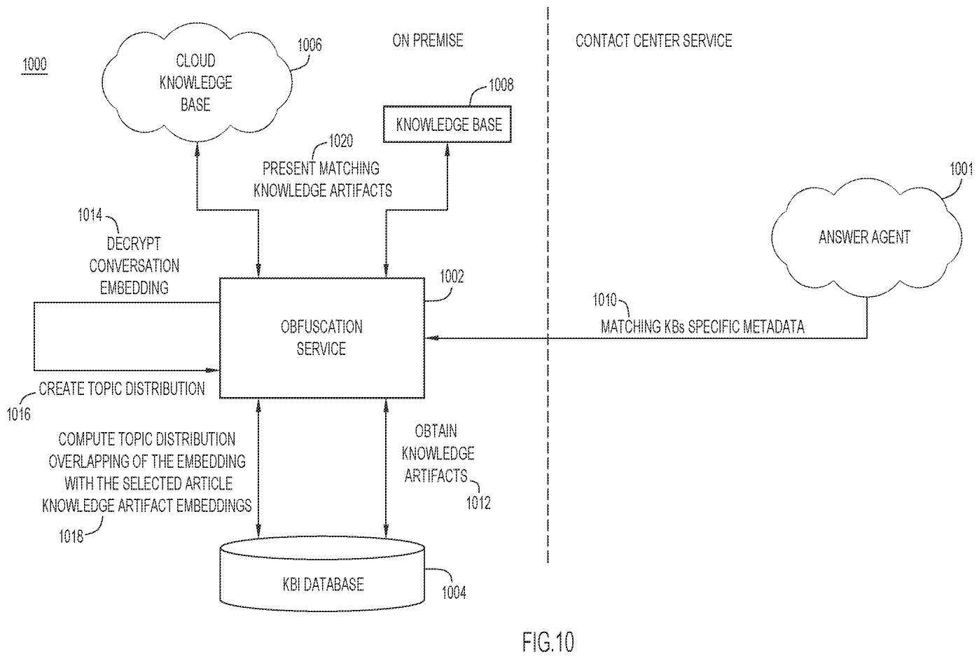

FIG. 10 is a diagram of a process 1000 for performing identification of knowledge artifacts, according to an example embodiment. As depicted, process includes an artificial agent 1001 on a contact center service side, and an obfuscation service 1002, KBI database 1004, and knowledge base 1008 on a customer's premises (e.g., “on premise,” a customer network). Also include is a cloud knowledge base 1006, which may be external to the customer network and/or contact center service.

At operation 1010, artificial agent 1001 provides the metadata of any embeddings determined to match a user query embedding (e.g., as determined using method 900 with reference to FIG. 9). The metadata may include UUIDs, and can be provided to obfuscation service 1002.

At operation 1012, obfuscation service 1002 accesses KBI database 1004 to retrieve the (unencrypted) knowledge artifacts using their UUIDs. Operations 1014, 1016, and 1018 may be performed in the case of article-type knowledge artifacts. At operation 1014, the user query embedding is decrypted, and a topic distribution for the conversation is generated at operation 1016. Next, at operation 1018, the topic distribution overlapping between the user query embedding and the selected article-type knowledge artifact embeddings is computed to determine whether any article topics do not overlap with the user's topic, in which case, those articles are excluded from further processing.

At operation 1020, the matching knowledge artifacts may be presented. These knowledge artifacts can be retrieved from their respective locations (e.g., in cloud knowledge base 1006 and/or knowledge base 1008), and provided to artificial agent 1001 for generation of a response to the user query.

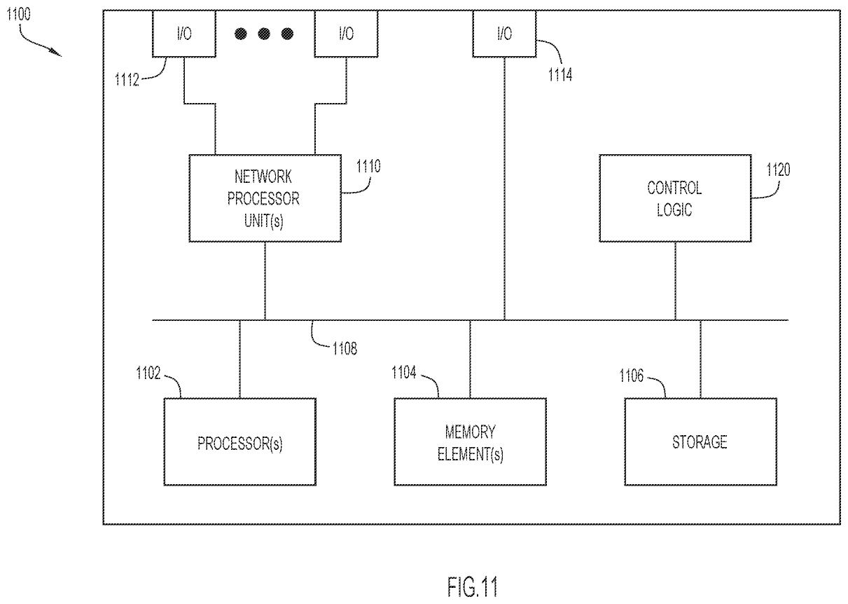

Referring now to FIG. 11, FIG. 11 illustrates a hardware block diagram of a computing device 1100 that may perform functions associated with operations discussed herein in connection with the techniques depicted in FIGS. 1-10. In at least one embodiment, the computing device 1100 may include one or more processor(s) 1102, one or more memory element(s) 1104, storage 1106, a bus 1108, one or more network processor unit(s) 1110 interconnected with one or more network input/output (I/O) interface(s) 1112, one or more I/O 1114, and 1120. In various embodiments, instructions associated with logic for computing device 1100 can overlap in any manner and are not limited to the specific allocation of instructions and/or operations described herein.

In at least one embodiment, processor(s) 1102 is/are at least one hardware processor configured to execute various tasks, operations and/or functions for computing device 1100 as described herein according to software and/or instructions configured for computing device 1100. Processor(s) 1102 (e.g., a hardware processor) can execute any type of instructions associated with data to achieve the operations detailed herein. In one example, processor(s) 1102 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1104 and/or storage 1106 is/are configured to store data, information, software, and/or instructions associated with computing device 1100, and/or logic configured for memory element(s) 1104 and/or storage 1106. For example, any logic described herein (e.g., 1120) can, in various embodiments, be stored for computing device 1100 using any combination of memory element(s) 1104 and/or storage 1106. Note that in some embodiments, storage 1106 can be consolidated with memory element(s) 1104 (or vice versa), or can overlap/exist in any other suitable manner.

In at least one embodiment, bus 1108 can be configured as an interface that enables one or more elements of computing device 1100 to communicate in order to exchange information and/or data. Bus 1108 can be implemented with any architecture designed for passing control, data and/or information between processors, memory elements/storage, peripheral devices, and/or any other hardware and/or software components that may be configured for computing device 1100. In at least one embodiment, bus 1108 may be implemented as a fast kernel-hosted interconnect, potentially using shared memory between processes (e.g., logic), which can enable efficient communication paths between the processes.

In various embodiments, network processor unit(s) 1110 may enable communication between computing device 1100 and other systems, entities, etc., via network I/O interface(s) 1112 (wired and/or wireless) to facilitate operations discussed for various embodiments described herein. In various embodiments, network processor unit(s) 1110 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1100 and other systems, entities, etc. to facilitate operations for various embodiments described herein. In various embodiments, network I/O interface(s) 1112 can be configured as one or more Ethernet port(s), Fibre Channel ports, any other I/O port(s), and/or antenna(s)/antenna array(s) now known or hereafter developed. Thus, the network processor unit(s) 1110 and/or network I/O interface(s) 1112 may include suitable interfaces for receiving, transmitting, and/or otherwise communicating data and/or information in a network environment.

I/O 1114 allow for input and output of data and/or information with other entities that may be connected to computing device 1100. For example, I/O 1114 may provide a connection to external devices such as a keyboard, keypad, mouse, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, 1120 can include instructions that, when executed, cause processor(s) 1102 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., 1120) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1104 and/or storage 1106 can store data, software, code, instructions (e.g., processor instructions), logic, parameters, combinations thereof, and/or the like used for operations described herein. This includes memory element(s) 1104 and/or storage 1106 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 602.11 (e.g., Wi-Fi®/Wi-Fi6®), IEEE 602.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of and’ one or more of can be represented using the ‘(s)’ nomenclature (e.g., one or more element(s)).

In some aspects, the techniques described herein relate to a method including: extracting a plurality of metadata objects from a plurality of knowledge artifacts in a database; encrypting a portion of the plurality of metadata objects using homomorphic encryption to generate a plurality of encrypted embeddings, wherein each encrypted embedding relates to content of a knowledge artifact; receiving a plurality of encrypted similarity scores that are generated by processing a query, received from a user, against the plurality of encrypted embeddings; decrypting the plurality of encrypted similarity scores to obtain a decrypted plurality of similarity scores; identifying a particular knowledge artifact based on the decrypted plurality of similarity scores; and providing a response to the user based on particular knowledge artifact.

In some aspects, the techniques described herein relate to a method, wherein each knowledge artifact of the plurality of artifacts is selected from a group of: a frequently asked question and corresponding answer, and an article.

In some aspects, the techniques described herein relate to a method, wherein an encrypted embedding is generated for each paragraph for the article.

In some aspects, the techniques described herein relate to a method, wherein the plurality of metadata objects that is not encrypted includes one or more of: a unique universal identifier for the corresponding knowledge artifact, a hash of the knowledge artifact, and a storage location of the knowledge artifact.

In some aspects, the techniques described herein relate to a method, wherein the portion of the plurality of metadata objects that is encrypted includes a topic and/or summary of the knowledge artifact, wherein the topic or the summary is generated using a trained machine learning model.

In some aspects, the techniques described herein relate to a method, further including: providing the plurality of encrypted embeddings and the query to a remote computing entity, wherein the plurality of encrypted similarity scores are generated by the remote computing entity, and wherein the query is encrypted using homomorphic embedding prior to being provided to the remote computing entity.

In some aspects, the techniques described herein relate to a method, further including: detecting an update to the database; and in response to detecting the update, generating an updated plurality of encrypted embeddings and providing the updated plurality of encrypted embeddings to the remote computing entity.

In some aspects, the techniques described herein relate to a method, wherein an artificial conversation agent obtains the query from the user and provides the response to the user.

In some aspects, the techniques described herein relate to a system including: one or more computer processors; one or more computer readable storage media; and program instructions stored on the one or more computer readable storage media for execution by at least one of the one or more computer processors, the program instructions including instructions to: extract a plurality of metadata objects from a plurality of knowledge artifacts in a database; encrypt a portion of the plurality of metadata objects using homomorphic encryption to generate a plurality of encrypted embeddings, wherein each encrypted embedding relates to content of a knowledge artifact; receive a plurality of encrypted similarity scores that are generated by processing a query, received from a user, against the plurality of encrypted embeddings; decrypt the plurality of encrypted similarity scores to obtain a decrypted plurality of similarity scores; identify a particular knowledge artifact based on the decrypted plurality of similarity scores; and provide a response to the user based on particular knowledge artifact.

In some aspects, the techniques described herein relate to a system, wherein each knowledge artifact of the plurality of artifacts is selected from a group of: a frequently asked question and corresponding answer, and an article.

In some aspects, the techniques described herein relate to a system, wherein an encrypted embedding is generated for each paragraph for the article.

In some aspects, the techniques described herein relate to a system, wherein the plurality of metadata objects that is not encrypted includes one or more of: a unique universal identifier for the corresponding knowledge artifact, a hash of the knowledge artifact, and a storage location of the knowledge artifact.

In some aspects, the techniques described herein relate to a system, wherein the portion of the plurality of metadata objects that is encrypted includes a topic and/or summary of the knowledge artifact, wherein the topic or the summary is generated using a trained machine learning model.

In some aspects, the techniques described herein relate to a system, further including: providing the plurality of encrypted embeddings and the query to a remote computing entity, wherein the plurality of encrypted similarity scores are generated by the remote computing entity, and wherein the query is encrypted using homomorphic embedding prior to being provided to the remote computing entity.

In some aspects, the techniques described herein relate to a system, wherein the program instructions further include instructions to: detect an update to the database; and in response to detecting the update, generate an updated plurality of encrypted embeddings and providing the updated plurality of encrypted embeddings to the remote computing entity.

In some aspects, the techniques described herein relate to a system, wherein an artificial conversation agent obtains the query from the user and provides the response to the user.

In some aspects, the techniques described herein relate to one or more non-transitory computer readable storage media having program instructions embodied therewith, the program instructions executable by a computer to cause the computer to perform operations including: extract a plurality of metadata objects from a plurality of knowledge artifacts in a database; encrypt a portion of the plurality of metadata objects using homomorphic encryption to generate a plurality of encrypted embeddings, wherein each encrypted embedding relates to content of a knowledge artifact; receive a plurality of encrypted similarity scores that are generated by processing a query, received from a user, against the plurality of encrypted embeddings; decrypt the plurality of encrypted similarity scores to obtain a decrypted plurality of similarity scores; identify a particular knowledge artifact based on the decrypted plurality of similarity scores; and provide a response to the user based on particular knowledge artifact.

In some aspects, the techniques described herein relate to one or more non-transitory computer readable storage media, wherein each knowledge artifact of the plurality of artifacts is selected from a group of: a frequently asked question and corresponding answer, and an article.

In some aspects, the techniques described herein relate to one or more non-transitory computer readable storage media, wherein an encrypted embedding is generated for each paragraph for the article.

In some aspects, the techniques described herein relate to one or more non-transitory computer readable storage media, wherein the portion of the plurality of metadata objects that is encrypted includes a topic and/or summary of the knowledge artifact, wherein the topic or the summary is generated using a trained machine learning model.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
extracting a plurality of metadata objects from a plurality of knowledge artifacts in a database;
encrypting a portion of the plurality of metadata objects using homomorphic encryption to generate a plurality of encrypted embeddings, wherein each encrypted embedding relates to content of a knowledge artifact;
receiving a plurality of encrypted similarity scores that are generated by processing a query, received from a user, against the plurality of encrypted embeddings;
decrypting the plurality of encrypted similarity scores to obtain a decrypted plurality of similarity scores;
identifying a particular knowledge artifact based on the decrypted plurality of similarity scores; and
providing a response to the user based on the particular knowledge artifact.

2. The method of claim 1, wherein each knowledge artifact of the plurality of knowledge artifacts is selected from a group of: a frequently asked question and corresponding answer, and an article.

3. The method of claim 2, wherein an encrypted embedding is generated for each paragraph for the article.

4. The method of claim 1, wherein the plurality of metadata objects that are not encrypted includes one or more of: a unique universal identifier for a corresponding knowledge artifact, a hash of the knowledge artifact, and a storage location of the knowledge artifact.

5. The method of claim 1, wherein the portion of the plurality of metadata objects that is encrypted includes a topic or summary of the knowledge artifact, wherein the topic or the summary is generated using a trained machine learning model.

6. The method of claim 1, further comprising:
providing the plurality of encrypted embeddings and the query to a remote computing entity, wherein the plurality of encrypted similarity scores are generated by the remote computing entity, and wherein the query is encrypted using homomorphic embedding prior to being provided to the remote computing entity.

7. The method of claim 6, further comprising:
detecting an update to the database; and
in response to detecting the update, generating an updated plurality of encrypted embeddings and providing the updated plurality of encrypted embeddings to the remote computing entity.

8. The method of claim 1, wherein an artificial conversation agent obtains the query from the user and provides the response to the user.

9. A system comprising:
one or more computer processors;
one or more computer readable storage media; and
program instructions stored on the one or more computer readable storage media for execution by at least one of the one or more computer processors, the program instructions comprising instructions to:
extract a plurality of metadata objects from a plurality of knowledge artifacts in a database;
encrypt a portion of the plurality of metadata objects using homomorphic encryption to generate a plurality of encrypted embeddings, wherein each encrypted embedding relates to content of a knowledge artifact;
receive a plurality of encrypted similarity scores that are generated by processing a query, received from a user, against the plurality of encrypted embeddings;
decrypt the plurality of encrypted similarity scores to obtain a decrypted plurality of similarity scores;
identify a particular knowledge artifact based on the decrypted plurality of similarity scores; and
provide a response to the user based on the particular knowledge artifact.

10. The system of claim 9, wherein each knowledge artifact of the plurality of knowledge artifacts is selected from a group of: a frequently asked question and corresponding answer, and an article.

11. The system of claim 10, wherein an encrypted embedding is generated for each paragraph for the article.

12. The system of claim 9, wherein the plurality of metadata objects that are not encrypted includes one or more of: a unique universal identifier for a corresponding knowledge artifact, a hash of the knowledge artifact, and a storage location of the knowledge artifact.

13. The system of claim 9, wherein the portion of the plurality of metadata objects that is encrypted includes a topic or summary of the knowledge artifact, wherein the topic or the summary is generated using a trained machine learning model.

14. The system of claim 9, further comprising:
providing the plurality of encrypted embeddings and the query to a remote computing entity, wherein the plurality of encrypted similarity scores are generated by the remote computing entity, and wherein the query is encrypted using homomorphic embedding prior to being provided to the remote computing entity.

15. The system of claim 14, wherein the program instructions further comprise instructions to:
detect an update to the database; and
in response to detecting the update, generate an updated plurality of encrypted embeddings and providing the updated plurality of encrypted embeddings to the remote computing entity.

16. The system of claim 9, wherein an artificial conversation agent obtains the query from the user and provides the response to the user.

17. One or more non-transitory computer readable storage media having program instructions embodied therewith, the program instructions executable by a computer to cause the computer to perform operations including:
extract a plurality of metadata objects from a plurality of knowledge artifacts in a database;
encrypt a portion of the plurality of metadata objects using homomorphic encryption to generate a plurality of encrypted embeddings, wherein each encrypted embedding relates to content of a knowledge artifact;
receive a plurality of encrypted similarity scores that are generated by processing a query, received from a user, against the plurality of encrypted embeddings;
decrypt the plurality of encrypted similarity scores to obtain a decrypted plurality of similarity scores;
identify a particular knowledge artifact based on the decrypted plurality of similarity scores; and
provide a response to the user based on the particular knowledge artifact.

18. The one or more non-transitory computer readable storage media of claim 17, wherein each knowledge artifact of the plurality of knowledge artifacts is selected from a group of: a frequently asked question and corresponding answer, and an article.

19. The one or more non-transitory computer readable storage media of claim 18, wherein an encrypted embedding is generated for each paragraph for the article.

20. The one or more non-transitory computer readable storage media of claim 17, wherein the portion of the plurality of metadata objects that is encrypted includes a topic or summary of the knowledge artifact, wherein the topic or the summary is generated using a trained machine learning model.
